(19) United States
(12) Patent Application Publication
(10) Pub. No.: US 2008/0215406 A1
(43) Pub. Date: Sep. 4, 2008

(54) Scheduling Resources for Airline Flights

(76) Inventors: Julian Pachon, Austin, TX (US); Marc Anderson, Austin, TX (US); David Staheli, Cedar Park, TX (US)

Correspondence Address: FISH & RICHARDSON P.C., P.O. BOX 1022, MINNEAPOLIS, MN, 55440-1022, US

(21) Appl. No.: 11/961,579

(22) Filed: Dec. 20, 2007

Related U.S. Application Data
(60) Provisional application No. 60/892,405, filed on Mar. 1, 2007.

(51) Int. Cl. G06Q 10/00

(52) U.S. Cl. 705/8

(57) ABSTRACT

Generally, there is provided an airline operations computing system and graphical user interface features that enable users to plan and conduct airline or other types of transportation operations effectively and time efficiently, and in addition, to do so in the face of disruptions due to weather, sick crew members, aircraft in need of repair, and the like. For example, a method and computer program product are provided for scheduling a resource to a scheduled airline flight or other transportation operation. The scheduling of the resource involves receiving a user input that associates a visual display of a selected flight or other transport pairing with a visual display of a selected candidate resource. In addition, a user interface display is provided that includes a listing area and a schedule area for performing scheduling functions.

### CROSS REFERENCE TO RELATED APPLICATIONS

This application claims priority from U.S. Provisional Application Ser. No. 60/892,405, filed Mar. 1, 2007, the contents of which are incorporated herein by reference.

### TECHNICAL FIELD

This document describes a transportation operations computing system that includes a suite of software applications.

### BACKGROUND

Sophisticated computing systems are needed to manage the operations of an airline. Airline operation computing systems exist that enable aircraft and crew planning, day-to-day operations management and reporting. In addition, airline operation computing systems exist that enable airlines to manage flight crews, equipment and passengers affected by service disruptions, such as weather or mechanical delays.

Typical airline operation systems are complex and are required to manage massive amounts of data. In addition, these systems are used in scenarios where the operations being managed can change very quickly, due to weather or mechanical delays. As such, the systems need to be easy to use, and allow decision making to be made very quickly.

### SUMMARY

Generally, there is provided an airline operations computing system with graphical user interface features that enable users to plan and conduct airline operations effectively and time efficiently, and in addition, to do so in the face of disruptions due to weather, sick crew members, aircraft in need of repair, and the like.

In one aspect, a computer-implemented method is provided for scheduling a resource to a scheduled airline flight. The method includes receiving a user selection of a flight pairing for which a resource is to be scheduled or changed. The method also includes filtering data files for resources to identify resources that are possible candidates to be scheduled for the selected flight pairing. The method further includes receiving a user input that associates a visual display of the selected flight pairing with a visual display of a selected candidate resource. The method includes also updating a resource schedule to indicate that the selected candidate resource is scheduled for the flight pairing.

In various implementations, the method may include one or more of the following optional features. The resources being assigned may be flight crew resources, aircraft resources, etc. The user input that associates the selected flight pairing with the selected candidate resource may a drag-and-drop action that drags the visual display of the flight pairing and drops the dragged visual display on the visual display of the selected candidate resource. Alternatively or additionally, the user input that associates the selected flight pairing with the selected candidate resource is a drag-and-drop action that drags the visual display of the selected resource and drops the dragged visual display on the visual display of the selected flight pairing.

In addition, the filtering of data files may include filtering by availability and identifying those resources that are available to be assigned to the flight pairing. The method may also include sorting the candidate resources identified through filtering, for example, by seniority.

Computer program products are also provided to carry out the above described methods of scheduling a resource to a scheduled airline flight. Such computer program products are tangibly embodied in computer storage medium and comprise instructions that when executed by a processor cause operations to be performed that carry out the above-described methods to schedule a resource to a scheduled airline flight. In addition, computing systems are provided that are programmed to carry out the above described methods to schedule a resource to a scheduled airline flight.

In another aspect, aspect, a user interface for managing operations of an airline or other similar carrier is provided. In particular, there is provided a computer program product tangibly embodied in computer storage medium and which comprises instructions that when executed by a processor generate a user interface display for managing operations of an airline.

The user interface includes a listing area and a schedule area. In the listing area there is listed at least one flight pairing that comprises a series of one or more flights, and at least one resource assigned to at least one of the listed at least one flight pairing. In the schedule display area there is displayed on a common timeline: a) for each listed pairing, a pairing schedule provided in relation to the common timeline, the pairing schedule including flight schedule details for each flight included in the listed pairing, and also including timing information for each such flight included in the listed pairing, which timing information is displayed in relation to the common timeline, and b) for each listed resource, a resource schedule provided in relation to the common timeline, the resource schedule including flight schedule details for each flight to which the resource is assigned, the resource schedule also including timing information for each such flight to which the resource is assigned, which timing information is displayed in relation to the common timeline.

In various implementations one or more of the following optional features may be included in relation to the user interface. The user interface display may further include a candidate resource area in which resources are displayed that can be assigned to a selected pairing included in the listing area. The schedule display area may include a timeline. The resource schedule may include assigned flights from at least two different pairings, with at least one of the at least two different pairings being listed in the listing area in association with the resource. The at least one resource listed in the listing area may be crewmember resources. The at least one resource listed in the listing area may be aircraft resources.

Further features and advantages may be understood with reference to the figures and the following description.

### DESCRIPTION OF DRAWINGS

FIG. 1A is a block diagram of one implementation of an airlines operation computing system, showing the various modules of application software programs that make up a suite.

FIG. 1B is a block diagram of one implementation of an airlines operation computing system, showing the various modules of application software programs that make up a suite with multiple clients.

FIG. 2 is a flow diagram of a computer-implemented method of scheduling a resource to a scheduled aircraft flight.

FIGS. 3A-3D show exemplary screen shots of how a pairing may be associated with an airline resource.

FIGS. 4A-4B are exemplary screen shots of how a pairing may be split into multiple pairings.

FIG. 5 is an exemplary screen shot showing schedules of a pairing and two crewmembers assigned to the pairing.

FIG. 6 is a block diagram of a generic computing system on which the various software-based methods may be executed.

Like numbers in different figures indicate like structures or processes.

### DETAILED DESCRIPTION

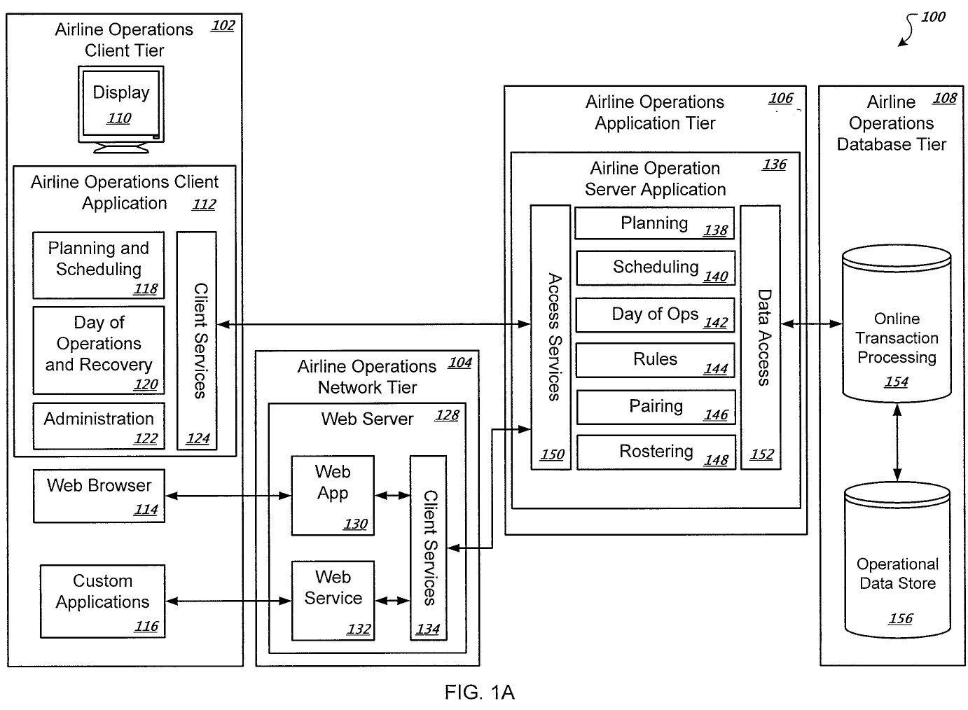

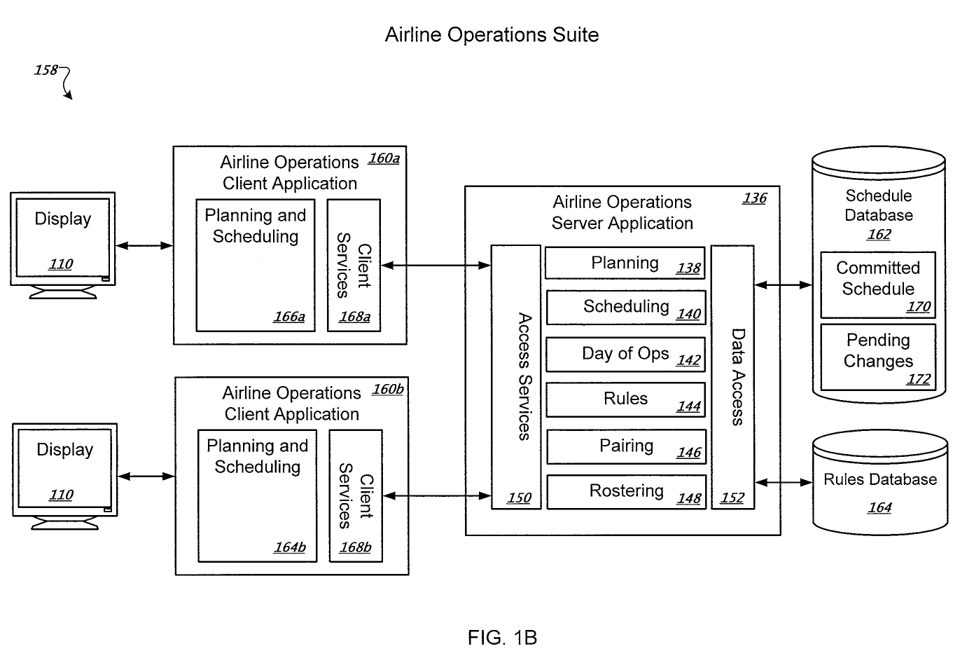

FIG. 1A is a block diagram of an implementation of an airline operations computing system 100, showing the various modules of application software programs that make up a suite. In general, the airline operations computing system 100 performs functions related to all aspects of an airline's operations functionality. This includes, planning, scheduling, and day-of-operations functions.

In the FIG. 1A example, the system 100 includes an airline operations client tier 102, an airline operations network tier 104, an airline operations application tier 106, and an airline operations database tier 108. In general, the airline operations client tier 102 performs functions that provide an interface through which a user may interact with the system 100. One such client tier 102 is shown in FIG. 1A for illustration purposes; typically there will be several such similarly functioning clients in a system in various different locations.

The airline operations client tier 102 includes a display device 110, an airline operations client application 112, a web browser 114, and a set of custom applications 116. The display device 110 may be the monitor of a computer, the screen of a portable device, the display of a mobile device, or other visual output device, by way of a few examples. The display device 110 provides a visual output for the airline operations client application 112, the web browser 113, and the set of custom applications 116.

The airline operations client application 112 includes number of software modules. In the FIG. 1 example, the modules are a planning and scheduling module 118, a day of operations and recovery module 120, an administration module 122, and a client services module 124. The planning and scheduling module 118 provides user interface functions for viewing and editing airline resource schedules, such as the schedules and assignments between scheduled flights, airplanes, and flight crews. This module 118 includes, for example, crew planning functions that comprise long-term staffing of flight crews, crew scheduling functions that comprise the production of pairing (discussed below) and flight crew rosters. For example, the planning and scheduling module 118 may display screens that allow the user to associate an airliner with a planned flight or series of flights, associate a crew with a flight or series of flights, and perform other tasks related to the planning and scheduling of flights and airline resources.

The planning and scheduling module 118 presents a user interface that may be used to display flight pairings, and to fill or make changes to such pairings. A pairing refers to a data structure for a specified flight or series of flights, in which data structure a resource such as a crewmember may be associated with the flight or series of flights. If a resource has not been assigned to the specified flight or series of flights, the pairing for that flight or series of flights may be referred to as an open pairing. The term pairing may also, depending on the context, refer to the actual association between a resource and the flight or series of flights, as in there is a pairing of a particular resource and a particular flight or series of flights. Also, a single flight or a series of multiple flights may be grouped together and referred to as a duty. Such a grouping may be created because it may have been deemed desirable to have a single resource assigned for the duty. In such a case, there may be a pairing for the grouped series of flights that constitute a duty.

The planning and scheduling module 118 presents a user interface that may be used to fill an open pairing by assigning a resource such as a flight crew member to it, and also to change a resource assignment for a pairing. This association between a resource and a specified flight or series of flight may be performed using a drag-and-drop operation. For example, the user may drag-and-drop a visual representation of a particular flight crewmember onto a visual representation of a scheduled flight or series of flights constituting a duty, or vice-versa, to associate the crewmember with the scheduled flight or series of flights. The same may be done, in some implementations, to associate other types of resources, such as a particular aircraft, with the flight or series of flights. In addition, there may be different groupings of flights for purposes of crew resources, as opposed to aircraft resources for example. In another example, the user may drag-and-drop a visual representation of a flight crewmember to a scheduled flight, or vice-versa, thereby associating the crewmember with the scheduled flight.

The planning and scheduling module 118 also may provide a visual indication that a pairing is being edited. For example, when a first user has selected and is operating an instance of the module 118 to edit a particular pairing (e.g., changing the pilot that is assigned to the pairing), the pairing may appear highlighted on the display device 110 to indicate that the pairing contains proposed changes that have not yet been committed so as to effect the proposed changes to the actual schedule. This may be useful, for example, if the user's attention is drawn away from the display device, and the user wants to be able to quickly determine the pairing for which the user was performing a scheduling action. In addition, another user using a different display device may be viewing the same pairing from another instance of the module 118, and in this case the pairing may be visually highlighted to indicate that the pairing is being edited by another user. This may be particularly useful in a scenario where there are multiple or even numerous schedulers, and a user may want to know whether or not someone else is performing a scheduling operation that would affect a pairing that the user is viewing.

The planning and scheduling module 118 may further provide a visual indication that a pairing assignment or a proposed change to a pairing assignment violates a predefined rule stored in a rules database. For example, a pilot may be assigned to a flight that will cause the pilot to exceed the number of hours a pilot may fly between rest periods. The planning and scheduling module 118 may cause an indicator to be displayed in association with the pairing, flight, or resource to indicate that the pairing violates one or more rules. Examples of rules may be guidelines based upon airline policy, union rules, airline regulatory organization (e.g., United States Federal Aviation Administration, FAA) rules, and other sources of rules and policies that may effect how flight resources are scheduled.

In some embodiments, a single indicator may be provided on a display to indicate the existence of one or more rule violations, be it one rule violation or multiple rule violations. In other embodiments, multiple indicators may be provided with each indicator indicating a different rule violation. In addition or alternatively, there may be multiple different appearance types for rule warnings, which appearance would indicate the nature or type of rule violation. For example, a pairing that may cause a non-critical rule warning (e.g., an overly large airplane being assigned to flight with few passengers) may be displayed with a “non-critical” warning icon. In another example, a pairing that may cause a pilot to break a law or flight regulation (e.g., flying too many hours without a rest period) may be displayed with a “critical” warning icon.

In some embodiments, multiple warning indicators may be used until a rule warning indicator limit is reached. For example, the planning and scheduling module 118 may display up to four individual indicators to indicate up to four rule violation warnings, but five or more rule warnings may be represented by another style of warning indicator. In the current example, five or more warnings may be indicated by a single icon that indicates the actual number of warnings, by four icons and an ellipsis, or by some other visual means to indicate multiple rule warnings.

The system 100 has an architecture, design and software functionality that enables the checking of proposed schedule changes to occur substantially in real-time. For example, the system 100 enables a user to edit a pairing and submit the proposed changes (but not commit them), and the system 100 will then check the edited pairing for rule violations before the changes are committed to the database. If the system 100 determines that the proposed pairing changes violate any of the rules, then the system 100 may indicate to the user any rule violation warnings that may have been generated, as described previously. The user may then choose to resolve any violations that may exist by making further changes (which also may be checked for rule violations in substantial real time), or leave the violations unresolved. The system 100 may, for example, provide rule violations relatively instantaneously on a display screen as a user is working on a pairing. After the user is satisfied with the schedule changes, the user may provide an input that commits the schedule changes. This may be done despite that there are rule violations, or in some cases, the user may have made further changes that resolved any intermediate changes that created one or more rule violations.

The day of operations and recovery module 120 provides general functionality for the day of operations management, as well as functionality for handling any daily disruptions. For example, the day of operations and recovery module 120 may provide functions that help the user reassign flight crews if a crewmember is unexpectedly absent from work, or if there are weather problems that disrupt flight operations. In another example, if an aircraft that is scheduled to a flight is grounded (e.g., needs unexpected repairs), then the module 120 may provide functions that help the user reassign aircraft to the scheduled flights.

The administration module 122 provides functionality for a user to edit airline resource information, security settings, rules parameters, or other administrative tasks. For example, an airline regulation that prohibits pilots from flying more than twelve hours without a rest period may be changed to a maximum of ten hours, and the administration module may allow the user to edit the rule parameter for maximum flight time to reflect the updated regulation.

The client services module 124 provides an applications programming interface (API) that handles one or more types of communications between the airline operations client tier 102 and the airline operations application tier 106. For example, the client services module 124 may encapsulate transmission control protocol/internet protocol (TCP/IP) messages, package user datagram protocol (UDP) datagrams, wrap web services messages, or manage other communications formats and protocols.

The web browser 114 is an application that provides a user with a means for interacting with hypertext markup language (HTML) pages and web applications. Examples of the web browser 114 may include Internet Explorer, available from Microsoft Corporation, Netscape Navigator, available from Netscape Communications and Weblogs, Inc., Firefox, available from Mozilla Corporation, and Opera Web Browser, available from Opera Software ASA.

The set of custom applications 116 may perform may provide a variety of different functions that are specific or unique to a particular airline. In many cases, there are standard software functions that apply generally to any airline and that will be delivered by a software vendor to an airline, and in addition, there may be additional custom applications that are either unique to a particular airline and/or provided by another vendor.

The airline operations network tier 104 in the FIG. 1A example includes a web server 128 to provide web service functionality in addition to or in lieu of direct access to the airline operations tier 106 provided by the client services module 124 provided in the client tier 102. The web server 128 includes a web application module 130, a web service module 132, and a client services module 134. The web application module 130 provides functions that allow a user to perform one or more functions of the airline operations client application 112 through the web browser 114.

In some embodiments, the client services module 134 of the web server 128 may be substantially the same as the client services module 124 of the airline operations client application 112. In some implementations, the web server client services module 134 may provide an API that may be used by the web application module 130 and the web service module 132 to communicate with the airline operations application tier 106.

The web service module 132 provides functions of a protocol bridge between the custom applications 116 and the airline operations application tier 106. For example, the web service module 132 may use Service Oriented Architecture Protocol (SOAP) messages use of an Internet application layer protocol as a transport protocol to communicate with the custom applications 116 over a network (e.g., the Internet).

In some implementations, the web service module 132 may receive SOAP messages from the custom applications 116, parse the SOAP messages, and use the client services module 134 to act as a bridge between the custom applications 116 and the airline operations application tier 106. In some implementations, the web service module 132 may translate data from the airline operations application tier 106 and the client services module 134, wrap the data as a SOAP message, and send the SOAP message to the custom applications 116. For example, the client services 116 may use an Internet connection and the web service module 132 to request and retrieve various types of airline operations data from the airline operations application tier 106.

The airline operations application tier 106 includes an airline operation server application 136. The airline operation server application 136 includes various modules that perform functions for the planning and scheduling of airline flight resources. Some of these modules include a planning module 138 (for long-term staffing of flight crews), a scheduling module 140 (for the production of pairings and rosters), day-of-operations module 142 (for day of operations management and recovery functions), a rules module 144, a pairing module 146, and a rostering module 148.

The airline operations sever application 136 also includes an access services module 150 and a data access module 152 to facilitate communication with the airline operations client application 112 (either directly or via the web server 128) and with the airline operations database tier 108. The access services module 150 communicates with the client services modules 124 and 134 of, respectively, the client application 112 and the web server 128. In some implementations, the access services module 150 may coordinate communications between the client services modules 124 and 134, and the server application modules 138-148. For example, an airline operations client application 112 may request that the airline operation server application 136 make a change to a flight resource. The access services module 150 may receive this request and respond by invoking functions of the scheduling module 140 and the rules module 144 to update a schedule and check for any rules violations that the change may cause.

The application tier's data access module 152 provides an API to handle tasks associated with database communications. In some implementations, the server application modules 138-148 may use the data access module 152 to create, update, and delete data contained in the airline operations database tier 108. For example, the data access module 152 may handle the tasks of opening and closing database connections, transaction processing, caching, and other tasks generally associated with database communications.

The planning module 138 provides functions that allow users to perform various tasks related to crew resource planning, for example, long-term staffing functions. For example, the module may allow users to plan for flight and reserve requirements, absence requests, training requirements, and other tasks that deal with airline resource planning. In some implementations, the planning module 138 may provide decision support and forecasting functions. For example, the module 138 may help users create efficient resource plans by compiling information to anticipate and correct resource surpluses and shortfalls.

The scheduling module 140 provides functions for airline scheduling tasks Airline scheduling may include, for example, the production of pairings and rosters, and the scheduling module 140 may build the pairings and build the rosters.

The day of operations module 142 provides functionality to manage generally the day of operations, which may include functionality for users to handle daily disruptions. For example, the module 142 may help users reassign flight crews if a crewmember is unexpectedly absent from work, or if there are weather problems that disrupt flight operations. In another example, if an aircraft that is scheduled to a flight is grounded (e.g., needs unexpected repairs), then the module 142 may provide functions that help the user reassign aircraft to the scheduled flights.

The rules module 144 performs functions that determine whether various airline operational rules have been violated. Examples of these rules-checking functions may include determining if a schedule will cause a pilot to fly more hours than is allowed by law or by policy, determining if a flight crew member assigned to a flight is qualified to work on the type of airplane that is assigned to the flight, determining if a proposed schedule provides insufficient time between flights for a flight crew member to move between airplanes, determining whether a schedule will cause an airplane to exceed a limit on the number of flight hours between maintenance operations, or other various rules and policies that may affect flights and flight resources. For example, if a pairing causes an aircraft to fly in excess of an allowable number of hours between service checks, the module 144 may detect this rule violation.

The pairing module 146 provides functionality for users to edit pairings. For example, a pairing is a sequence of flight legs in which crewmembers are paired with flights that start at a crew base or originating airport, and end at the same crew base. The pairing module 146 provides functions for users to add, remove, change, or perform other functions that associate flight resources with pairings.

The rostering module 148 provides functions that generate and manage crew rosters. For example, the rostering module 148 may help users determine work schedules according to various fairness criteria, such as by crew preferences, by seniority, or by other factors that may be used to generate crew rosters. In some implementations, rostering functionality may be included in the scheduling module 140.

The airline operations database tier 108, in the FIG. 1A example, includes an online transaction processing (OLTP) database 154 and an operational data store (ODS) database 156. The OLTP database 154 may include one or more tables of data used for airline operations. For example, the airline operations data may include flight crew data, flight schedule data, flight schedule proposals, rules parameters, rules warnings, and other data that may be used for airline operations. In some implementations, the OLTP database 154 may be a data warehouse that is used by the airline operation server application 136. For example, the OLTP database 154 may be accessed by the data access module 152 to provide database functions to the modules 138-148 of the airline operation server application 136.

In some implementations, the data in the OLTP database 154 may be partly or wholly copied to the ODS database 156. For example, data in the OLTP database 154 may be replicated or mirrored to the ODS database 156. The ODS database 156 may integrate data from multiple sources (e.g., one or more tables within one or more databases) to facilitate operations, analysis, and reporting. For example, the ODS database 156 may be configured for online analytical processing (OLAP). In some implementations, the ODS database 156 may be structured and configured differently than the OLTP database 154. For example, database tunings and structures for OLTP operations may not work well for OLAP operations, and by using separate databases for OLTP and OLAP operations, the OLTP database 154 may be structured and tuned as needed for OLTP operations and the ODS database 156 may be structured and tuned to OLAP operations.

FIG. 1B is a block diagram of one implementation of an airline operations computing system 158 that is similar to the system 100 shown in FIG. 1A but showing different aspects of the system. FIG. 1B shows various modules of application software programs that make up a suite, and also shows multiple clients. The example system 158 includes multiple airline operations client applications, there being two such applications 160a and 160b shown in FIG. 1B for clarity, although in typical scenarios there are many more. The FIG. 1B system 158 also has an airline operations server application 136, a schedule database 162, and a rules database 164.

The airline operations client applications 160a and 160b each perform functions for their respective users to do airline resource planning and scheduling, for example. In some embodiments, the airline operations client applications 160a and 160b may each be implementations of the airline operations client application 112 of FIG. 1A, and thus the applications 160a and 160b provide the same functionality. The airline operations client applications 160a and 160b show their outputs on respective display devices 110.

The airline operations client applications 160a and 160b each includes a planning and scheduling module 166a and 166b, and a client services module 168a and 168b. In some embodiments, the planning and scheduling modules 166a and 166b may be the planning and scheduling module 118 of FIG. 1A. For example, the planning and scheduling modules 166a and 166b may display screens that allow the user to associate an aircraft with a planned flight or series of flights, associate a crew with a flight or series of flights, and perform other tasks related to the planning and scheduling of flights and airline resources.

The client services modules 168a and 168b each provides an applications programming interface (API) that handles one or more types of communications between the airline operations client applications 160a and 160b and the airline operations server application 136. In some embodiments, the client services modules 168a and 168b may be the client services module 124 shown in FIG. 1A.

The schedule database 162 may include tables of airline operations data. The schedule database 162, in the FIG. 1B example, includes a committed schedule table 170 and a pending changed table 172. The committed schedule table 170 may include data that describes airline flight resource schedules. The pending changes table 172 may include data that describes proposed changes to airline flight resource schedule data included in table 170. For example, a user may request to view a schedule, and the airline server application 136 may query the committed schedule table 170 for schedule data. The user may propose to make changes to the schedule data, and those proposed changes may be stored in the pending changes table 172 without data in table 170. If the proposed changes are approved, the airline operations server application 136 may cause one or more of the proposed schedules to be applied to the schedule data in the committed schedule table 170 and removed from the table 172.

The rules database 164 includes airline operations rules. For example, the rules module 144 may include a rule that checks to determine if a pilot has flown more than “N” hours in an “M” hour period. The values for “N” and “M” may be stored in the rules database and queried by the rules module 144 to define the number of hours a pilot may fly in a certain period.

In some embodiments, the rules module 144 may perform functions for a user to edit rule parameters in the rules database 164. For example, the rules database may include parameters that reflect an airline policy, such as a ratio of flight hours to training hours. The rules database may store a value of “1000” to define this ratio, but this ratio may need to be changed (e.g., airline policy change, pilot union contract change, FAA regulations change) to a value of “900.” The rules module 144 may provide functions for a user to update the ratio or other rule parameters stored in the rules database 164.

In various implementations, airline schedules may be planned to comply with various rules. These rules may implemented to reflect various laws, regulations, policies, and other such guidelines that may be put forth by governments, regulatory agencies (e.g., the Federal Aviation Administration, FAA), unions, corporations, or other entities. Rules may be implemented in computer code, such as in the code of the rules module 144. In some implementations, rules may contain parameters (e.g., variables) that may permit quantitative or other types of parameters that may be stored elsewhere (e.g., the rules database 164). The rules engine 144 may obtain the specific values of rule parameters by loading the rule parameters from storage. By storing the specific values of rule parameters separately from the computer code that defines the rules, the rules may be adjusted without requiring edits to the computer code of the rules engine 144. In some implementations, rules may be edited by using a computer implemented method and user interface.

As will be described in more detail later, a process or method is provided by which rule checking is performed in a very immediate or “real-time” manner, such that a user who is in the process of making edits to a schedule is provided nearly instantaneous feedback on a display device if a proposed change violates any of many rules that may need to be followed with the schedule. Such a rule-checking and display process may be performed even before the proposed changes are actually “committed” to the schedule, or in other words, before the scheduling user enters into the system that a set of proposed changes will be made to the schedule. Such a rule-checking and display method is particularly useful in the context of an airline operations system in which there may be many rules that apply to scheduling. Some of those rules will be mandatory, and thus must be followed, whereas others may be guidelines or preferences that may be ignored in some cases. Before turning to the rule checking process, there will first be a discussion of the rules database, and how the rules database and parameters for the rules may be updated or edited.

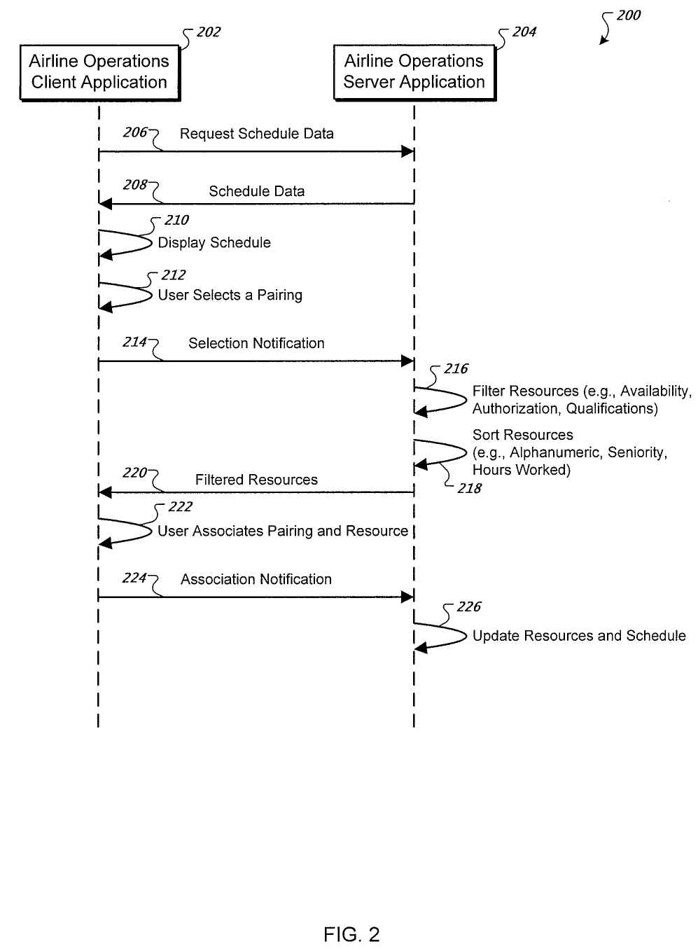

FIG. 2 is flow diagram of an example computer-implemented method 200 for scheduling a resource for an airline flight or series of flights. The method 200 includes operations to associate, using a graphical user interface (GUI), a displayed representation of the resource with a displayed representation of the flight or series of flights. Examples of resources that may be scheduled in this manner include personnel or crew resources, aircraft resources, etc. In addition to the scheduling of resources for an airline operation, the techniques and methods described in this document may apply to other types of carrier operations, such as railway, for example, passenger services on a railway, bus operations, etc. The example method 200 illustrates the operations within and between an airline operations client application 202 and an airline operations server application 204. In some embodiments, the airline operations client application 202 may be the airline operations client application 112 of FIG. 1A. In some embodiments, the airline operations server application 204 may be the airline operations server application 136 of FIG 1A.

The method 200 begins with step 206 wherein the client application 202 generates a request that schedule information or data be retrieved from a database where that information is stored. This may be initiated, for example, by a user providing an input to a user entry device at a client device, which input is a request to display schedule information on a display device associated with the client device. The server application 204 receives the request and responds in step 208 by sending the requested schedule data to the requesting client application 202. The schedule data may include, for example, information about various flights and series or flights, and resource assignments for those flights and series of flights, if any.

Next, at step 210, the client application 202 generates a visual display of the schedule data on a display device (e.g., the display 110 of FIG. 1). The visual display may include, for example, a Gantt chart diagram of various scheduled flights and/or groups of scheduled flights that have been grouped together. The displayed flights and series of flights constitute various pairings that may either already be filled or that may be revised by subsequent scheduling operations. Using the visual display, a user would then, at step 212, select a displayed pairing (that is, a flight or series of flights). This may be done, for example, by clicking on a visual representation of the pairing using a pointing device such as a mouse.

When a user has selected a particular pairing at the client application 202, a message or notification of that selection is sent, at step 214, to the server application 204. In response, at step 216, the server application 204 retrieves and filters data files of resources to identify the resources that can be scheduled for the pairing. For example, the server application 204 may filter resources based on resource availability, authorization, qualifications, training, or other criteria that may be used to filter a collection of airline resources. In addition, the server application 204 may also prioritize the resources that can be scheduled for the flight or series of flights. This may be accomplished by step 218 that involves a sorting of the filtered resources. For example, at step 218 the collection may be sorted by alphanumeric order, by seniority, hours worked, or by other attributes that may be used to sort a collection of airline resources.

Next, at step 220, the collection of filtered and sorted resources is sent to the client application 202, where visual representations of the resources are displayed on the client display device. The retrieval and display of resources may be initiated, in some embodiments, immediately by a user selecting of a pairing. In other embodiments, the retrieval and display of resources may not be initiated until a user selects that the resources that can be scheduled for a pairing be displayed. For example, and as will be shown later by illustration, a graphical user interface (GUI) may include a series of selectable tabs that are each associated with a different resource type (flight crewmember, aircraft etc.), and the retrieval and display of the resources of a particular type may not be initiated until the corresponding resource type tab is selected.

At this point, the visual display includes both visual representations of one or more flights or series of flights (with perhaps the selected flights or series of flights highlighted in some way) and visual representations of resources that can be scheduled for the selected flight or series of flights. Using this visual display and an appropriate user input device such as a mouse or keyboard, a user associates, at step 222, a flight or series of flights (that is, a pairing) with a particular resource. For example, a user may drag-and-drop a visual representation of a particular aircraft shown in a filtered aircraft resource collection to a visual representation of a pairing, or vice-versa. This associates the aircraft with the pairing. In another example, a pairing may be dragged-and-dropped onto a crewmember's name in a filtered crewmember resource collection, or vice-versa, to associate the pairing and the crewmember.

In response to the association having been made, a message or notification of the user's association between the pairing and the resource is sent from the client application 202 to the server application 204, at step 224. In response, at step 226, the server application 204 updates the collection of available resources and schedule data to reflect the association between the pairing and the airline resource. The association may be a proposed one for which the user is not yet committed. In addition, the user may commit the proposed schedule change to effect an actual change in the schedule. This may be done, for example, by the user providing at the client application 202 an input, perhaps guided by the visual display, that is indicative of such a commit of a proposed schedule change.

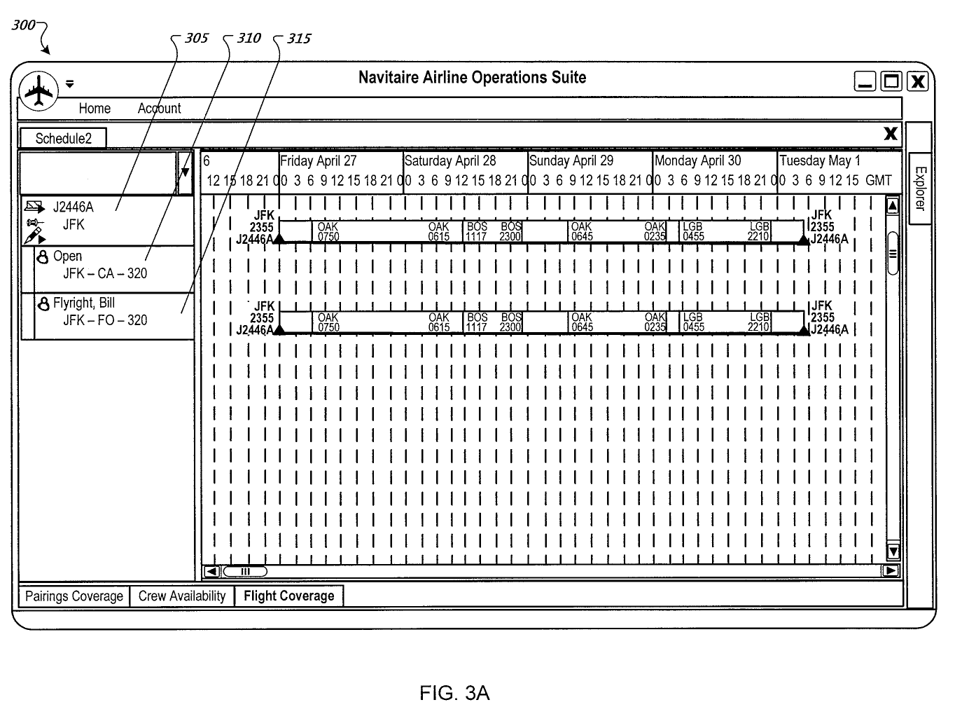

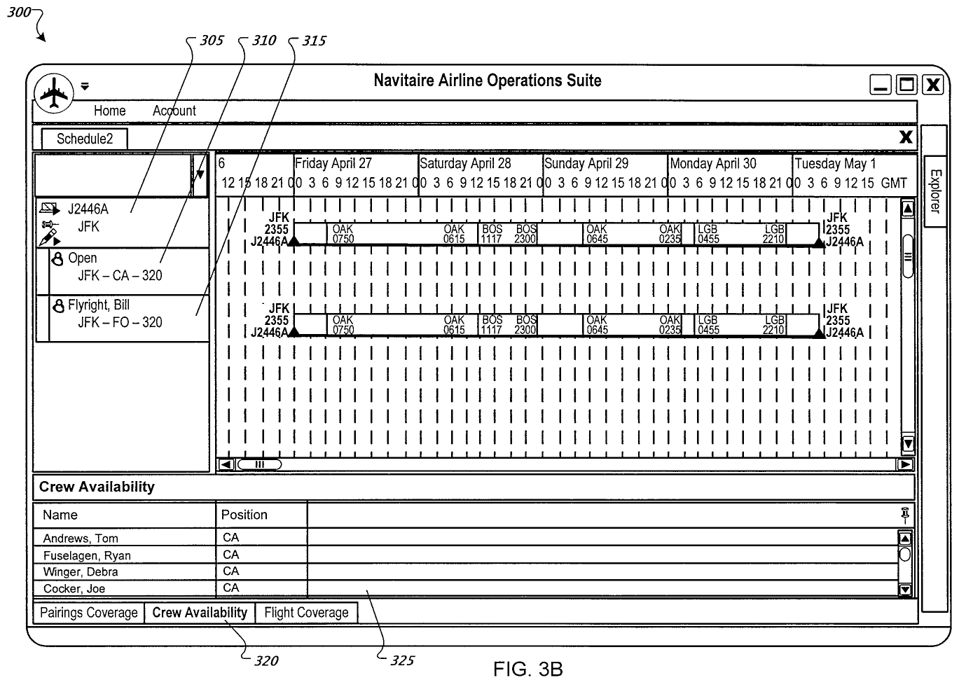

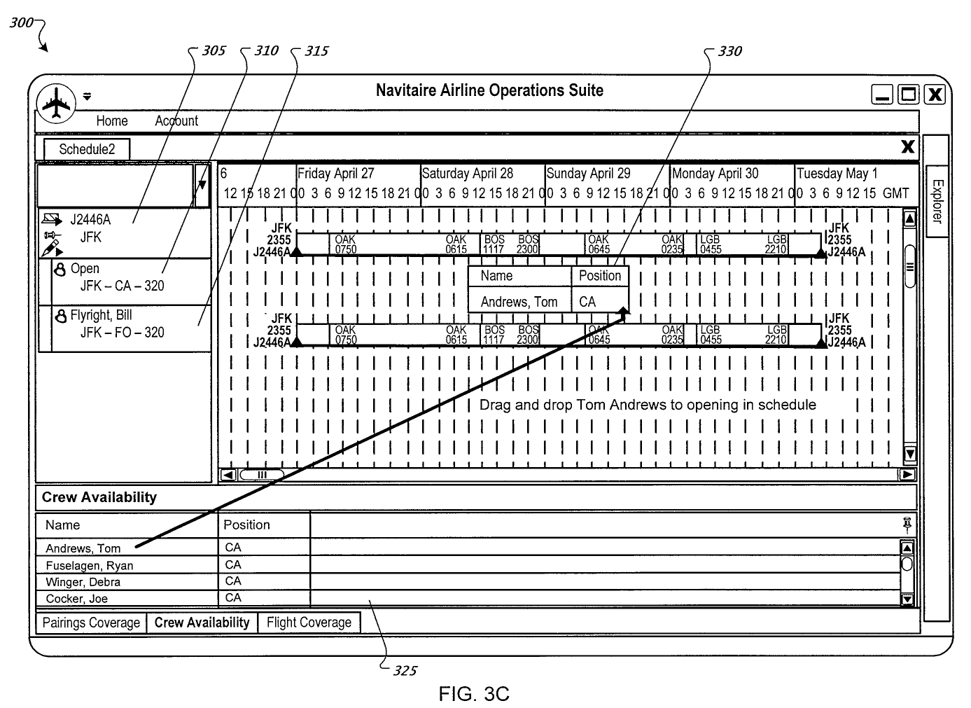

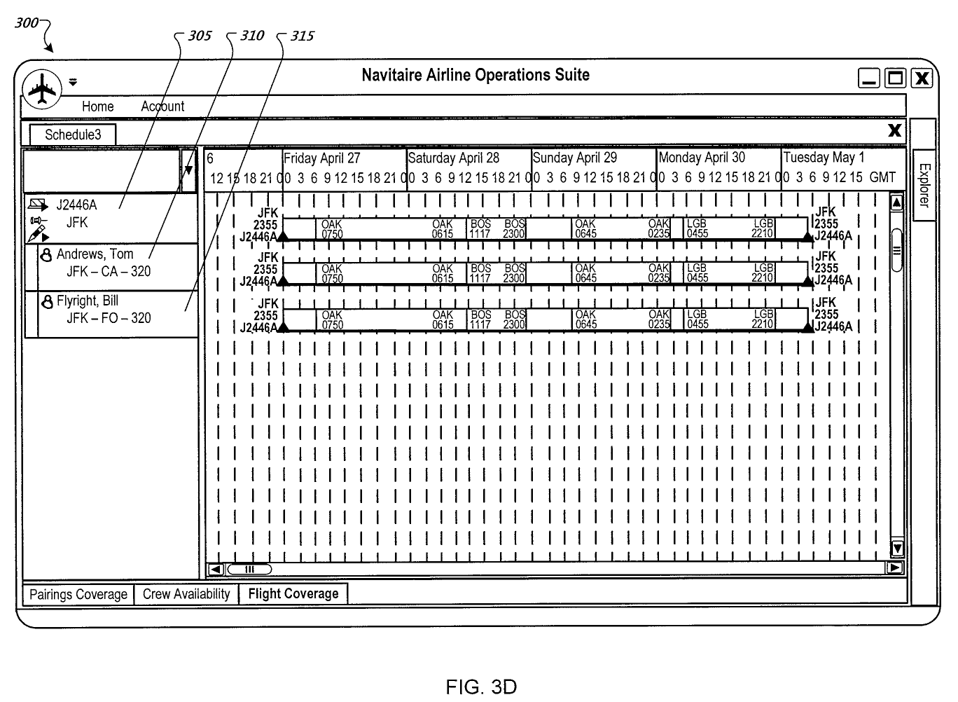

Now referring to FIGS. 3A-3D, there are shown an example series of screen snapshots of a client application graphical user interface (GUI) visual display 300 provided during the course of the FIG. 2 method in which a pairing is associated with an resource. FIG. 3A show the visual display 300 that includes a schedule of various scheduled flights. This display 300 may be provided, for example, at step 210 of the FIG. 2 method, after the schedule data has been requested and received from the server application 204.

The display 300 includes a large area in which a Gantt chart display is provided of various scheduled flights. In the FIG. 3A example, there are two copies of the same series of flights. The top copy of the series of flights illustrates a pairing for all crewmembers, and the bottom copy of the series of flights illustrates the pairing for one crewmember, first officer Bill Flyright. In the FIG. 3A screenshot, the illustrated pairing includes five duties. A duty may be referred to as one or more activities that collectively begin and end with a rest (for example but not always, an overnight). In the FIG. 3A example, the five duties are five separate flights. As shown in FIG. 3A, the captain slot for the pairing is currently not assigned, although the first officer slot is already assigned as Bill Flyright.

In the FIG. 3A example, the displayed pairing includes a series of five flights, namely, a flight from JFK airport in New York to Oakland (OAK), a flight from Oakland to Boston (BOS), a flight from Boston back to Oakland, a flight from Oakland to Long Beach, Calif. (LGB), and a flight from Long Beach back to JFK airport in New York. In this example, the pairing starts and ends from the same airport, JFK. Airport codes and flight times of departure and arrival are shown for each of the flights of the duty on the Gantt chart strips. In addition, a unique identifier for the duty is provided at the beginning and end of the Gantt chart strip. In this example, the identifier is 32446A.

At the left-hand side of the FIG. 3A visual display 300 is the pairing information 305 for the displayed pairing. The pairing 305 includes a captain (CA) position 310 and a first officer (FO) position 315. As mentioned, the example of FIG. 3A illustrates the first officer pairing as having been filled with a pilot named Bill Flyright, whereas the captain pairing is currently an open pairing. Although in the FIG. 3A-3C example, the overall pairing Gantt chart display is shown to be the same size as the Gantt chart pairing display the crewmembers, in other embodiments they may be sized on the GUI differently, for example, with the overall pairing Gantt chart display being larger than that for each crewmember.

Turning now to the next screen snapshot 300 shown in FIG. 3B, there is shown a resulting display following a user having selected, for example with a pointing device such as a mouse, one of the selectable tabs labeled “crew availability” 320. As such, the area at the lower part of the screen above the series of user-selectable tabs provides a list view of various crewmembers 325 that can be assigned to the pairing. As discussed previously, the collection of available flight crewmembers may be filtered by crewmember availability, qualification, location, or other attribute that may be used to filter crewmembers. In addition, in some embodiments, the collection of available flight crewmembers may be sorted by alphabetical order, by seniority, hours flown, or by other attribute that may be used to sort crewmembers.

FIG. 3C is the next in the series of screen snapshots, and depicts an association being made on the graphical user interface (GUI) between a selected visual representation of a particular crewmember and a visual representation of a series of flights (the pairing 32446A) for which a captain is not currently assigned. In this example, the association between a selected captain resource and the series of flights is made by a drag-and-drop operation. For example, FIG. 3C illustrates that a user has selected “Andrews, Tom” from the collection of available flight crewmembers 325, and has dragged a visual representation of “Andrews, Tom” 330 to the visual representation of the series of flights. Because the selected crewmember 330 is a captain, the selected crewmember is associated with the captain pairing for the pairing.

FIG. 3D is the final screen snapshot of this series, and illustrates that the user has dropped the visual representation of “Andrews, Tom” 330 to the series of flights, and thus has filled the captain pairing 310 for the series of flights. The left-hand side of the display 300 reflects this change by displaying the name “Andrews, Tom” in the captain pairing 310. Now that are three Gantt chart strips on the visual display, one for all resources of the pairing (on top), one for the captain pairing (middle), and one for the first officer pairing (bottom).

As opposed to dragging a resource to a scheduled flight to make the association, alternatively a flight may be dragged to a resource. For example, in the display 300, the user may be able to drag a visual representation of the captain pairing 310 to a name in the collection of available flight crewmembers 325 to associate the pairing with the crewmember.

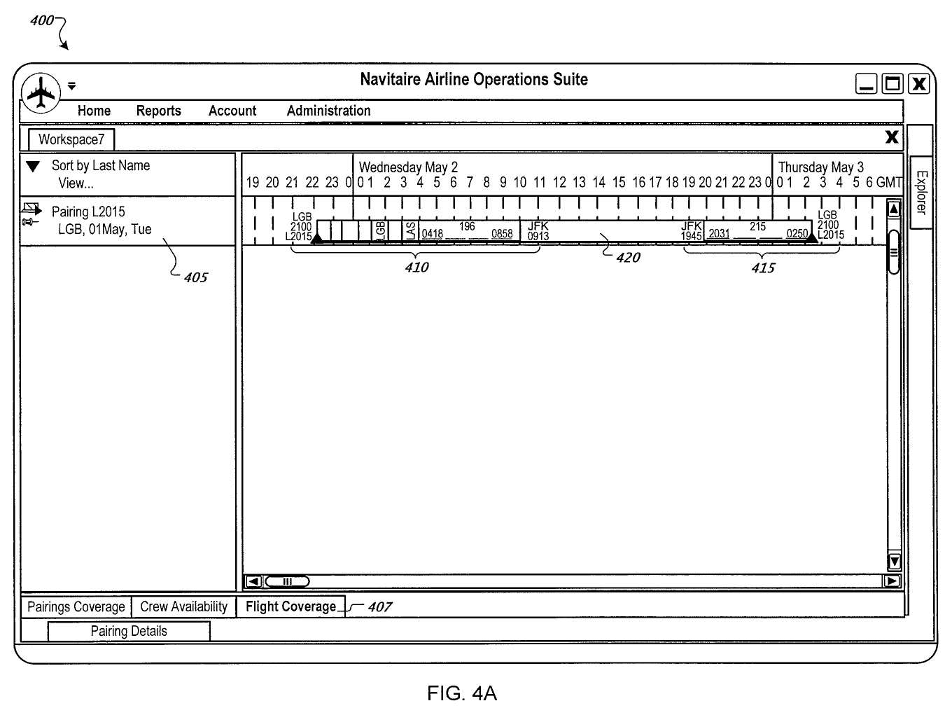

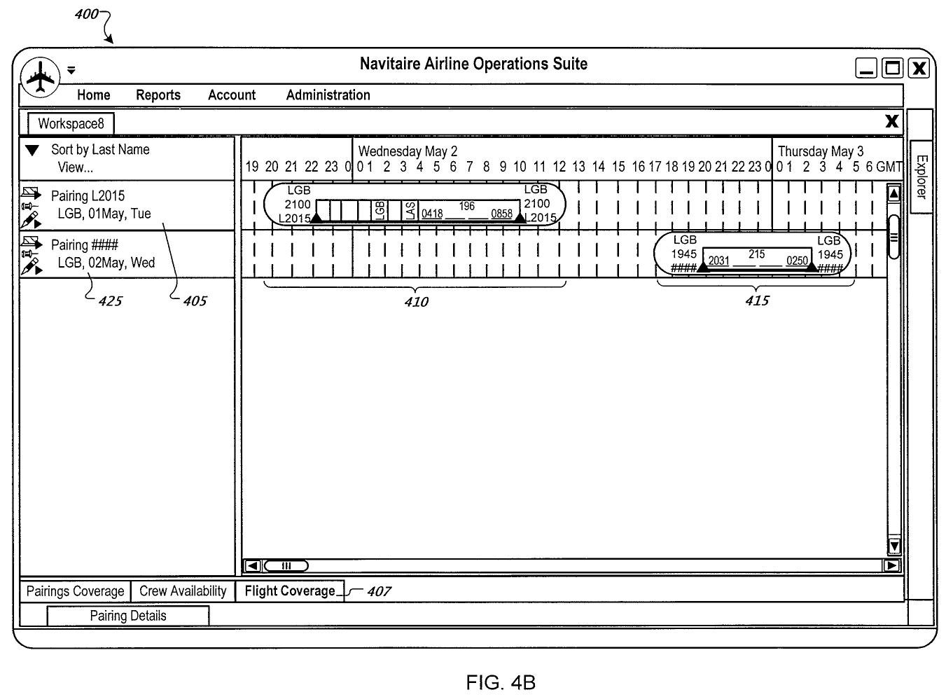

Referring now to FIGS. 4A-4B, there is illustrated functionality for splitting a pairing into two separate pairings. This may be done for a variety of reasons. For example, it may be that one crewmember cannot serve for all of the duties that make up the pairing. FIG. 4A is a screen snapshot of a user interface display 400 of a single pairing 405, pairing number L2015. In that the “flight coverage” tab 407 at the bottom of the user interface is selected, the display 400 shows a list of pairings, although in the FIG. 4A display on one pairing is listed. As shown in the Gantt chart display area, the pairing 405 includes a first series 410 of flights and a second series 415 of flight (the latter being a single flight).

It may be desirable to split the first series 410 from the second series 415 so as to create two pairings from a single pairing. This may be done, for example, by a user entering a command to split a displayed pairing at a particular point in time within the pairing. For example, a user may navigate a pointing device to location 420 and enter a right click operation on the pointing device to provide a display of options, one of which may be a “split” operation. As such, the pairing L2015 may be split at that selected point. Such a “split” operation would produce the user interface display 400 shown in FIG. 4B. As shown there, the first pairing L2015 (numbered 405) includes only one of the two original series, namely, the first series 410, and a new pairing 425 (not yet numbered) is created that is made up of the second series.

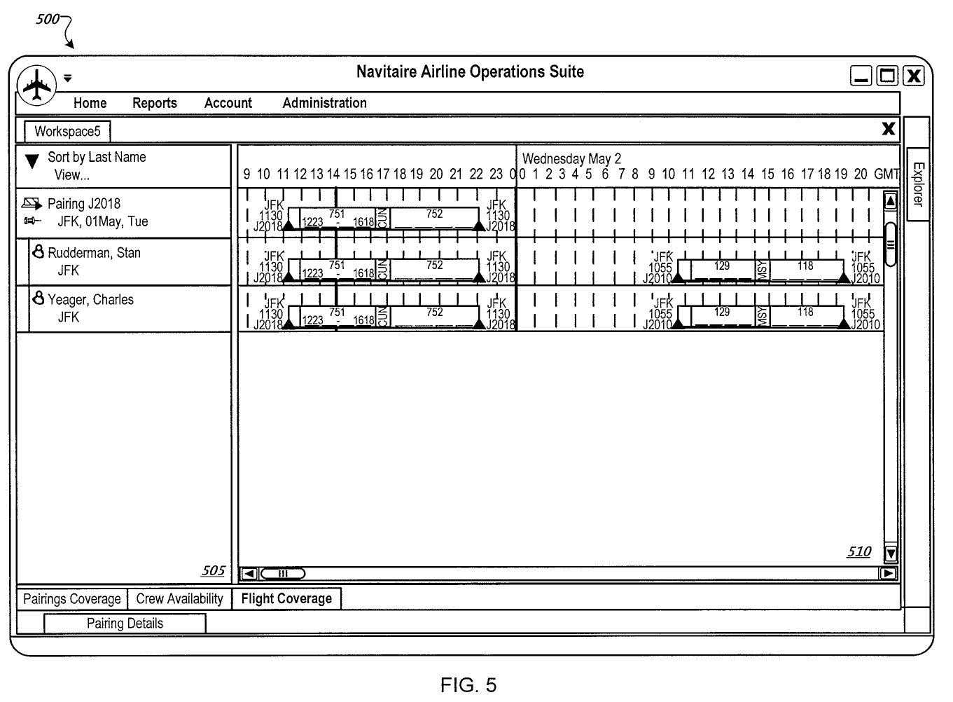

Referring now to FIG. 5, there is shown another user interface display 500 of another useful aspect of the scheduling display features provided in this document. In this display 500, details for pairing J2018 listed in a list area 505 are provided in a Gantt chart display area 510 as in previously described displays. The Gannt chart display area 510 has a horizontal time axis, and in the FIG. 5 display, May 1^{st} and May 2^{nd} are displayed. In the list area 505 there is listed two crewmembers Stan Rudderman and Charles Yeager that are assigned to the pairing J2018. The display shown in FIG. 5 of assigned crewmembers may be generated under a pairing using, for example, an “expand” feature.

Pairing J2018 in the FIG. 5 example includes two flights, both of which are scheduled for May 1. As such, the pairing J2018 includes only a single duty on a single day. The crewmembers' schedules are shown in the Gantt chart display area 510 in their entirety, and not just the parts of the crewmembers' schedules that are included in the pairing. As can be seen, both crewmembers shown in FIG. 5 are also assigned to another pairing the next day, May 2. The pairing to which they are assigned is pairing number J2010. As such, the constraints of crewmembers assigned to a pairing can be seen by a scheduler, which may be useful if, for example, the crewmember may wish to revise the pairing in some way.

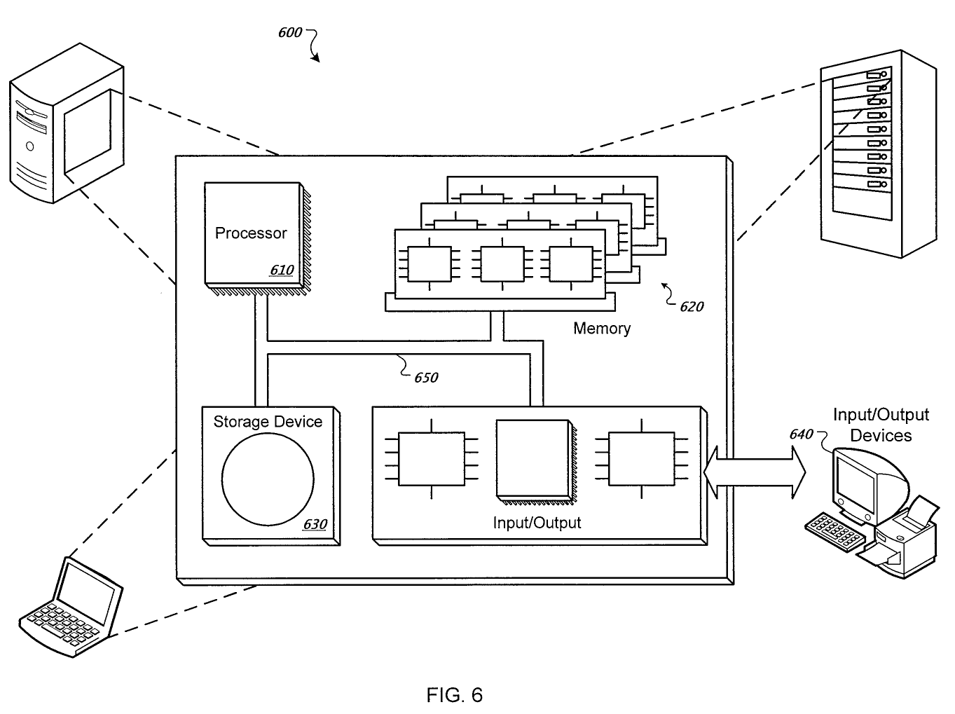

FIG. 6 is a schematic of a general computing system 600. The system 600 can be used for the operations described in association with any of the computer-implement methods described previously, according to one implementation. The system 600 includes a processor 610, a memory 620, a storage device 630, and an input/output device 640. Each of the components 610, 620, 630, and 640 are interconnected using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 may be a floppy disk device, a hard disk device, an optical disk device, or a tape device.

The input/output device 640 provides input/output operations for the system 600. In one implementation, the input/output device 640 includes a keyboard and/or pointing device. In another implementation, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

Although the embodiments described above have been described in terms of airline operations, embodiments for other purposes are possible. For example, the systems described may be modified to schedule and associate crews and equipment for land transportation (e.g., rail, busses, taxis, limousines, trucks), watercraft (e.g., ships, ferries), aircraft, spacecraft, industrial equipment (e.g., fishing trawlers, oil rigs), construction equipment, mining equipment, military equipment (e.g., tanks, patrol vehicles, reconnaissance vehicles), or other types of operations where a schedule of crews or operators may be associated with a vehicle or other machine. The described systems may also be modified for use in scenarios that do not necessarily include a vehicle. For example, the systems described may be modified for use by a travel agency to schedule and associate tour guides, tourists, tour stops, hotels, restaurants, transportation, or other items that may be associated with a tour package.

Although a few implementations have been described in detail above, other modifications are possible. For example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer-implemented method for scheduling a resource to a scheduled airline flight, the method comprising:
receiving a user selection of a flight pairing for which a resource is to be scheduled or changed;
filtering data files for resources to identify resources that are possible candidates to be scheduled for the selected flight pairing;
receiving a user input that associates a visual display of the selected flight pairing with a visual display of a selected candidate resource; and
updating a resource schedule to indicate that the selected candidate resource is scheduled for the flight pairing.

2. The method of claim 1, wherein the resources are flight crew resources.

3. The method of claim 1, wherein the user input that associates the selected flight pairing with the selected candidate resource is a drag-and-drop action that drags the visual display of the flight pairing and drops the dragged visual display on the visual display of the selected candidate resource.

4. The method of claim 1, wherein the user input that associates the selected flight pairing with the selected candidate resource is a drag-and-drop action that drags the visual display of the selected resource and drops the dragged visual display on the visual display of the selected flight pairing.

5. The method of claim 1, wherein the filtering of data files comprises filtering by availability and identifying those resources that are available to be assigned to the flight pairing.

6. The method of claim 1 further comprising sorting the candidate resources identified through filtering.

7. The method of claim 1 wherein the sorting of the candidate resources is by seniority.

8. A computer program product tangibly embodied in a computer storage medium and comprising instructions that when executed by a processor cause operations to be performed for scheduling a resource to a scheduled airline flight, the operations comprising:
receiving a user selection of a flight pairing for which a resource is to be scheduled or changed;
filtering data files for resources to identify resources that are possible candidates to be scheduled for the selected flight pairing;
receiving a user input that associates a visual display of the selected flight pairing with a visual display of a selected candidate resource; and
updating a resource schedule to indicate that the selected candidate resource is scheduled for the flight pairing.

9. The computer program product of claim 8, wherein the resources are flight crew resources.

10. The computer program product of claim 8, wherein the user input that associates the selected flight pairing with the selected candidate resource is a drag-and-drop action that drags the visual display of the flight pairing and drops the dragged visual display on the visual display of the selected candidate resource.

11. The computer program product of claim 8, wherein the user input that associates the selected flight pairing with the selected candidate resource is a drag-and-drop action that drags the visual display of the selected resource and drops the dragged visual display on the visual display of the selected flight pairing.

12. The computer program product of claim 8, wherein the filtering of data files comprises filtering by availability and identifying those resources that are available to be assigned to the flight pairing.

13. The computer program product of claim 8, wherein the operations further comprise sorting the candidate resources identified through filtering.

14. The computer program product of claim 8, wherein the sorting of the candidate resources is by seniority.

15. A computer program product tangibly embodied in an information and comprising instructions that when executed by a processor generate a user interface display for managing operations of an airline that comprises:
a listing area in which there is listed at least one flight pairing that comprises a series of one or more flights, and at least one resource assigned to at least one of the listed at least one flight pairing;
a schedule display area in which there is displayed on a common timeline:
a) for each listed pairing, a pairing schedule provided in relation to the common timeline, the pairing schedule including flight schedule details for each flight included in the listed pairing, and also including timing information for each such flight included in the listed pairing, which timing information is displayed in relation to the common timeline; and
b) for each listed resource, a resource schedule provided in relation to the common timeline, the resource schedule including flight schedule details for each flight to which the resource is assigned, the resource schedule also including timing information for each such flight to which the resource is assigned, which timing information is displayed in relation to the common timeline.

16. The computer program product of claim 15, wherein the user interface display further comprises a candidate resource area in which resources are displayed that can be assigned to a selected pairing included in the listing area.

17. The computer program product of claim 15, wherein the schedule display area includes a timeline.

18. The computer program product of claim 15, wherein the resource schedule includes assigned flights from at least two different pairings, at least one of which at least two different pairings is listed in the listing area in association with the resource.

19. The computer program product of claim 15, wherein the at least one resource listed in the listing area are crewmember resources.

20. The computer program product of claim 15, wherein the at least one resource listed in the listing area are aircraft resources.
